(19) United States
(12) Patent Application Publication
(10) Pub. No.: US 2025/0033432 A1
(43) Pub. Date: Jan. 30, 2025

(54) AIR CONDITIONER FOR VEHICLE

(71) Applicant: Hanon Systems, Daejeon (KR)

(72) Inventors: Seung Ho LEE, Daejeon (KR); Seo Jun YOON, Daejeon (KR); Sang Ki LEE, Daejeon (KR); Chang Sun PARK, Daejeon (KR); Cheol Han JANG, Daejeon (KR); Yong Sik KIM, Daejeon (KR)

(73) Assignee: Hanon Systems, Daejeon (KR)

(21) Appl. No.: 18/267,552

(22) PCT Filed: Sep. 8, 2022
(86) PCT No.: PCT/KR2022/013522

§ 371 Date: Jun. 15, 2023

(30) Foreign Application Priority Data
Oct. 6, 2021 (KR) 10-2021-0132527

(51) Int. Cl. B60H 1/00

(52) U.S. Cl. CPC B60H 1/00514; B60H 1/00471; B60H 2001/00092

(57) ABSTRACT

An embodiment provides an air conditioner for a vehicle, the air conditioner including an air conditioning unit having a heat exchanger disposed therein, and a blower unit configured to supply air to the air conditioning unit, in which the blower unit includes a blower casing having an inner surface, and a blower configured to allow the air to flow toward the inner surface, in which the inner surface includes a first surface, and a second surface disposed on the first surface and inclined, and in which the first and second surfaces divide a direction of the air, which is allowed to flow by the blower, into at least two directions. Therefore, the air conditioner for a vehicle may improve performance and quality of the blower unit.

### TECHNICAL FIELD

Embodiments relate to an air conditioner for a vehicle. Specifically, embodiments relate to an air conditioner for a vehicle, in which performance and quality of a blower unit configured to supply air to an air conditioning unit are improved by an inner shape of a blower casing and a structure of a blower.

### BACKGROUND ART

A vehicle is equipped with an air conditioner for adjusting an air temperature and ventilation in the interior of the vehicle. The air-conditioning device produces warm air to keep the interior of the vehicle warm in the winter season or produces cold air to keep the interior of the vehicle cool in the summer season.

Further, the air conditioner for a vehicle may include an air conditioning unit configured to adjust a temperature of air by means of heat exchange between air and a heat exchange medium, and a blower unit configured to supply air to the air conditioning unit. Further, the air conditioner for a vehicle may include an intake unit provided to supply outside air or inside air to the blower unit.

FIG. 1 is a view illustrating an intake unit and a blower unit in the related art.

With reference to FIG. 1, a blower unit 10 in the related art may supply air, which is introduced through an intake unit 20 into which air (inside air or outside air) is introduced, to an air conditioning unit.

The intake unit 20 may include an intake casing 21 having an inside air inlet port 21a and an outside air inlet port 21b formed at one side thereof, and a switching door 22 configured to selectively open or close the inside air inlet port 21a and the outside air inlet port 21b.

Further, the blower unit 10 may include a blower casing 11, and a blower 12 disposed in the blower casing 11. The blower casing 11 has a bell mouth 11a formed to communicate with the intake casing 21, and an outlet portion 11b formed to communicate with the air conditioning unit. In this case, the blower 12 may include a hub 13, a plurality of wheels 14 disposed on the hub 13, and a band 15 configured to fix the wheels 14. Further, the hub 13 may be rotated by an actuator 16 configured as a motor or the like.

A flow of air formed by the rotation of the wheels 14 may collide with an inner surface 11c of the blower casing 11 and then form a flow of air flowing toward the outlet portion 11b.

In this case, the air flowing toward the outlet portion 11b may implement various flows of air by means of an assembling tolerance of the blower 12 coupled to the blower casing 11 and roughness of the inner surface 11c.

Further, as the types of flows of air are diversified and the number of flows of air increases, there occurs a problem in which interference or the like occurs between the flows of air, and ventilation resistance increases because of the interference.

Further, the ventilation resistance is a main factor that degrades performance of the blower unit 10.

In addition, when an air flow rate increases, there is a problem in that vibration of the blower 12 increases, which decreases quality of the blower unit 10.

Accordingly, there is a need for an air conditioner for a vehicle structurally improved to improve the performance and quality of the blower unit.

### DISCLOSURE

### Technical Problem

An embodiment provides an air conditioner for a vehicle structurally improved to improve performance and quality of a blower unit.

Technical problems to be solved by the embodiment are not limited to the above-mentioned technical problems, and other technical problems, which are not mentioned above, may be clearly understood by those skilled in the art from the following descriptions.

### Technical Solution

The object is achieved by an air conditioner for a vehicle, the air conditioner including: an air conditioning unit having a heat exchanger disposed therein; and a blower unit configured to supply air to the air conditioning unit, in which the blower unit includes: a blower casing having an inner surface; and a blower configured to allow the air to flow toward the inner surface, in which the inner surface includes: a first surface; and a second surface disposed on the first surface and inclined, and in which the first and second surfaces divide a direction of the air, which is allowed to flow by the blower, into at least two directions.

In this case, the blower may include: a hub; a plurality of first wheels disposed on an upper surface of the hub and spaced apart from one another in a circumferential direction; a band configured to connect upper portions of the plurality of first wheels; and a drive part configured to rotate the hub, and the upper surface of the hub may be formed as a curved surface and guide air to a boundary region in which the first and second surfaces meet together.

Further, the curved surface may include: a first curved surface formed to be convex upward; and a second curved surface formed to be concave downward.

In addition, the boundary region may be disposed to have a predetermined offset from an imaginary line that traverses an axial center of the first wheel in a radial direction.

In addition, the boundary region may be disposed to be lower than an imaginary line that traverses an axial center of the first wheel in a radial direction.

In addition, a flow of air formed in a radial direction by the blower may form vortices by means of the first and second surfaces, and a direction of the vortex formed by the first surface and a direction of the vortex formed by the second surface may be opposite to each other.

In addition, the band may include: a horizontal portion configured to connect upper edges of the plurality of first wheels; an upper sleeve protruding upward from the horizontal portion; and a lower sleeve protruding downward from the horizontal portion,
and a radial thickness of the lower sleeve may be larger than a radial thickness of the upper sleeve. In this case, an inner peripheral surface of the horizontal portion may be formed as an inclined surface inclined outward. Further, the upper sleeve may be disposed to overlap the lower sleeve in an axial direction.

In addition, the blower casing may further include a reverse flow prevention protrusion protruding downward from a ceiling surface, and an end of the reverse flow prevention protrusion disposed outside the band may be disposed to overlap the upper sleeve of the band in a radial direction.

In addition, the blower casing may further include a reverse flow prevention protrusion protruding downward from a ceiling surface, and an end of the reverse flow prevention protrusion disposed outside the band may be disposed to overlap a horizontal portion of the band in a radial direction.

In addition, the blower may further include support ribs configured to connect lower portions of the first wheel and the upper surface of the hub. In this case, an upper surface of the support rib may be formed as a curved surface formed to be concave downward.

In addition, the blower may further include a plurality of second wheels disposed on a lower surface of the hub and spaced apart from one another in a circumferential direction.

The object is achieved by an air conditioner for a vehicle, the air conditioner including: an air conditioning unit having a heat exchanger disposed therein; and a blower unit configured to supply air to the air conditioning unit, in which the blower unit includes: a blower casing; and a blower configured to allow air to flow in the blower casing, in which the blower includes: a hub; a plurality of wheels disposed on the hub and spaced apart from one another in a circumferential direction; a band configured to connect upper portions of the plurality of wheels; and a drive part configured to rotate the hub, in which the band includes: a horizontal portion configured to connect upper edges of the plurality of wheels; and an upper sleeve protruding upward from the horizontal portion, in which the blower casing includes a reverse flow prevention protrusion protruding downward from a ceiling surface, and in which an end of the reverse flow prevention protrusion disposed outside the band is disposed to overlap an upper sleeve of the band in a radial direction.

Further, the band may further include a lower sleeve protruding downward from the horizontal portion, and a radial thickness of the lower sleeve may be larger than a radial thickness of the upper sleeve.

### Advantageous Effects

The embodiment may improve the performance of the blower unit by means of the internal structure of the blower casing and the shape of the hub of the blower corresponding to the internal structure of the blower casing. Specifically, the internal structure of the blower casing and the shape of the hub of the blower may be used to divide the flow of air, which is formed as the air collides with the blower casing, into at least two flows, thereby minimizing ventilation resistance. Therefore, it is possible to ensure a consistent air flow rate of air to be supplied to the air conditioning unit through the blower unit, thereby improving the performance of the blower unit.

The embodiment provides the example of the arrangement position of the blower corresponding to the internal structure of the blower casing, thereby further improving the performance of the blower unit.

The embodiment may reduce vibration generated by the blower by improving the shape of the band disposed in the blower.

The embodiment may use the rib for supporting the wheel disposed in the blower, thereby reducing vibration generated by the blower. In this case, it is possible to guide the flow of air to the boundary region formed in the blower casing by improving the shape of the rib.

Various useful advantages and effects of the embodiments are not limited to the above-described contents and will be more easily understood from descriptions of the specific embodiments.

### BRIEF DESCRIPTION OF THE DRAWINGS

FIG. 1 is a view illustrating a blower unit in the related art.

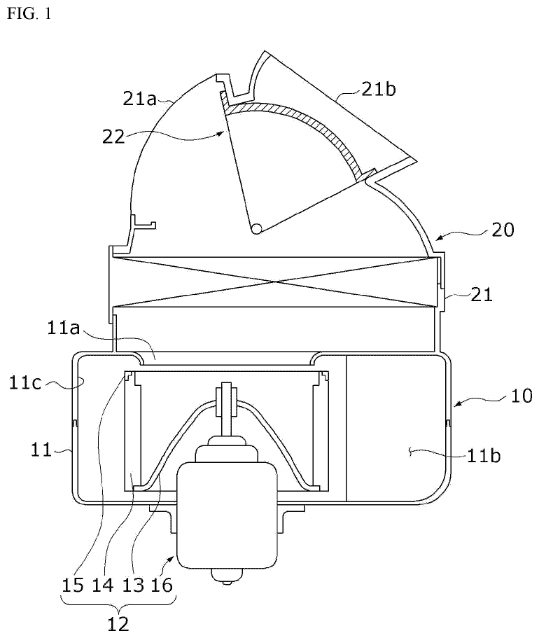

FIG. 2 is a view illustrating an air conditioner for a vehicle according to an embodiment.

FIG. 3 is a perspective view illustrating a blower unit of the air conditioner for a vehicle according to the embodiment.

FIG. 4 is a cross-sectional view taken along line A-A in FIG. 3 and illustrating a first embodiment of the blower unit.

FIG. 5 is an enlarged view of region A in FIG. 4.

FIG. 6 is a top plan view illustrating a blower of the blower unit according to the first embodiment.

FIG. 7 is a cross-sectional view illustrating a blower casing disposed in the blower unit according to the first embodiment.

FIG. 8 is a cross-sectional view illustrating a hub of the blower disposed in the blower unit according to the first embodiment.

FIG. 9 is a cross-sectional view taken along line A-A in FIG. 3 and illustrating a second embodiment of the blower unit.

FIG. 10 is an enlarged view of region B1 in FIG. 9.

FIG. 11 is an enlarged view of region B2 in FIG. 9.

FIG. 12 is a top plan view illustrating a blower of the blower unit according to the second embodiment.

FIG. 13 is a graph illustrating performance of the blower unit according to the embodiment.

### MODE FOR INVENTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination among a plurality of associated listed items.

When an element is referred to as being “connected” or “coupled” to another element, it will be understood that the element can be directly connected or coupled to another element, or other elements may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, when embodiments are described in detail with reference to the accompanying drawings, components that are the same or correspond to each other will be denoted by the same or corresponding reference numerals in all drawings, and redundant descriptions will be omitted.

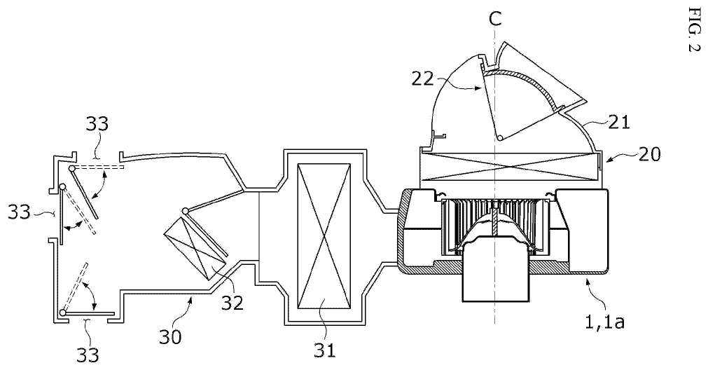

FIG. 2 is a view illustrating an air conditioner for a vehicle according to an embodiment.

With reference to FIG. 2, an air conditioner for a vehicle according to an embodiment may include a blower unit 1 (1a) according to the embodiment, an intake unit 20, and an air conditioning unit 30. In this case, the blower unit 1 (1a) may be disposed between the intake unit 20 and the air conditioning unit 30 based on a flow of air. Therefore, the blower unit 1 (1a) may use a blower to supply air, which is introduced through the intake unit 20, to the air conditioning unit 30. In this case, the blower unit 1 (1a) may be detachably disposed on the intake unit 20 and the air conditioning unit 30.

The intake unit 20 may include an intake casing 21 having an inside air inlet port 21a and an outside air inlet port 21b. The inside air inlet port 21a is formed at one side of the intake unit 20 to introduce inside air, and the outside air inlet port 21b is formed at one side of the intake unit 20 to introduce outside air. The intake unit 20 may include a switching door 22 configured to selectively open or close the inside air inlet port 21a and the outside air inlet port 21b.

The air conditioning unit 30 may include at least one heat exchanger 31 or 32 configured to adjust a temperature of the air by means of heat exchange between a heat exchange medium and the air supplied by the blower unit 1 (1a). Therefore, the air with the temperature or the like adjusted in the air conditioning unit 30 may be discharged into an occupant compartment through a plurality of vents 33. In this case, the heat exchanger may be an evaporator or heater.

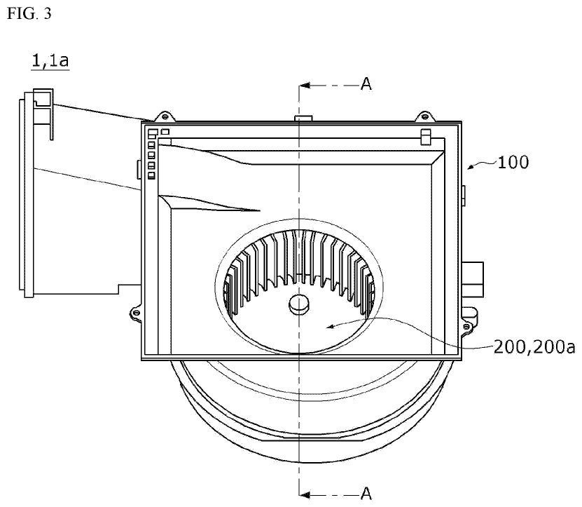

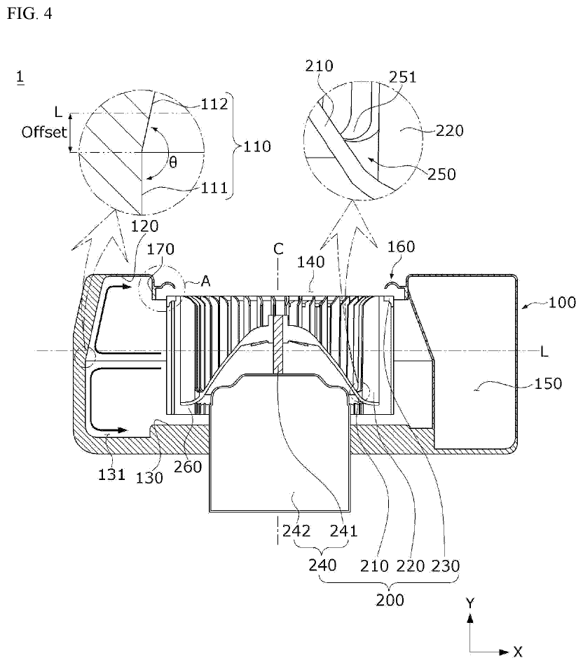

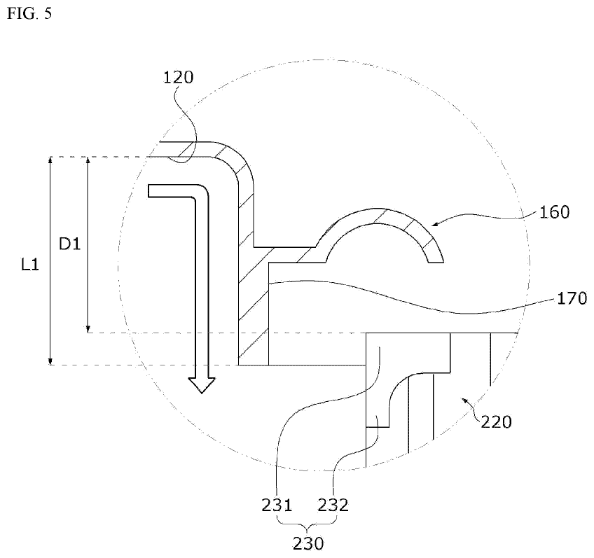

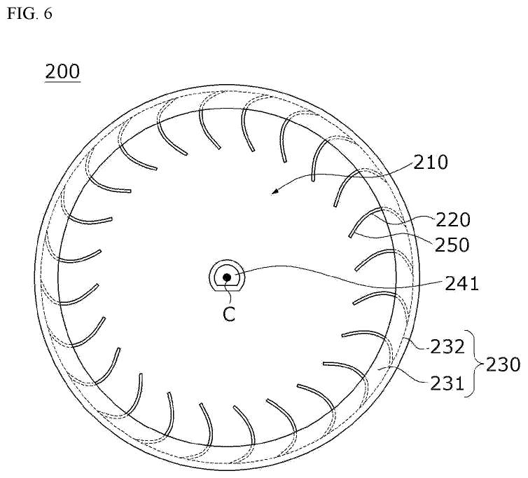

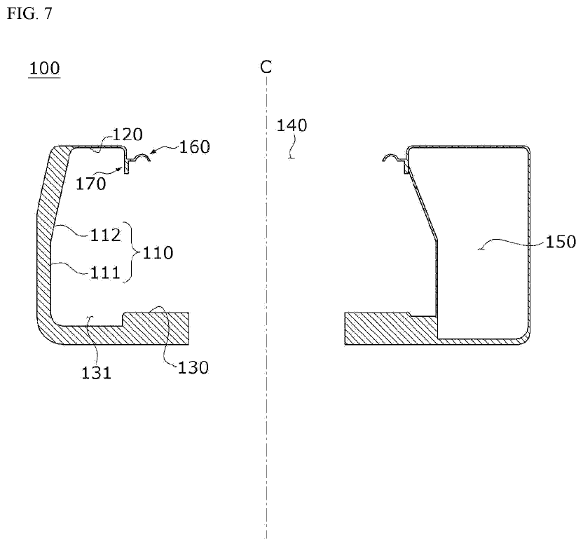

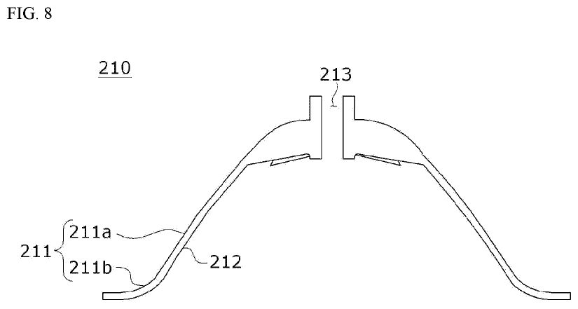

FIG. 3 is a perspective view illustrating a blower unit of the air conditioner for a vehicle according to the embodiment, FIG. 4 is a cross-sectional view taken along line A-A in FIG. 3 and illustrating a first embodiment of the blower unit, FIG. 5 is an enlarged view of region A in FIG. 4, FIG. 6 is a top plan view illustrating a blower of the blower unit according to the first embodiment, FIG. 7 is a cross-sectional view illustrating a blower casing disposed in the blower unit according to the first embodiment, and FIG. 8 is a cross-sectional view illustrating a hub of the blower disposed in the blower unit according to the first embodiment. In this case, an X direction illustrated in FIG. 4 may mean a radial direction, and a Y direction may mean an axial direction. Further, the axial direction and the radial direction may be perpendicular to each other. Further, a direction defined along a circle having a radius in the radial direction based on an axial center may be referred to as a circumferential direction. In addition, reference numeral ‘C’ illustrated in FIG. 4 may mean a rotation center (axial center) of the blower. In addition, the axial direction may be divided into an upward direction and a downward direction. For example, a direction toward the intake unit 20 may mean the upward direction. Further, the downward direction may mean a direction opposite to the upward direction. In addition, the arrows indicated in the blower casing in FIG. 4 and the arrow indicated in FIG. 5 may indicate the flows of air.

The blower unit 1 according to a first embodiment may include a blower casing 100 having a space formed therein, and a blower 200 disposed in the space and configured to allow the air to flow. In this case, the blower casing 100 may be referred to as a scroll casing.

With reference to FIGS. 4 and 7, the blower casing 100 may have the space. Therefore, the blower casing 100 may include an inner surface 110, a ceiling surface 120, and a bottom surface 130 formed therein. In this case, the term ‘inside’ may mean a direction toward an axial center C based on the radial direction, and the term ‘outside’ may mean a direction opposite to the inside.

In addition, the blower casing 100 may include an inlet 140 formed to communicate with the intake unit 20, and an outlet 150 formed to communicate with the air conditioning unit. In this case, the inlet 140 may be formed at an upper side of the blower casing 100. Therefore, when the blower 200 operates, the air introduced into the blower casing 100 through the inlet 140 may be guided by the inner surface 110 or the like and then discharged to the outlet 150.

The inner surface 110 may include a first surface 111, and a second surface 112 disposed to be inclined with respect to the first surface 111. For example, the second surface 112 may be disposed to be inclined inward from an upper end of the first surface 111. In this case, the second surface 112 may be disposed to have a predetermined inclination angle θ with respect to the first surface 111. Further, the inclination angle θ may be an obtuse angle of less than 180 degrees. In particular, the inclination angle θ may be defined within a range of 120 to 170 degrees.

Further, a region in which the first surface 111 and the second surface 112 meet together may be formed to have a predetermined range in an axial direction by being rounded or the like. Therefore, the region in which the first surface 111 and the second surface 112 meet together may be referred to as a boundary region or an inflection region. Alternatively, the first surface 111 and the second surface 112 may define an edge defined by the inclination angle θ, and the edge may be referred to as a boundary line or an inflection line. The edge may also be included in a boundary region.

The first surface 111 and the second surface 112 may divide a direction in which the air is allowed to flow by the blower 200 into at least two directions. Therefore, the flows of air, which are allowed to flow by the blower 200, may be broadly divided into a flow of air formed by the first surface 111, and a flow of air formed by the second surface 112.

In particular, as illustrated in FIG. 4, the upper air, which is discharged by the blower 200 and disposed at an upper side, may be guided to form a vortex by the second surface 112 that is an inclined surface. Further, as the vortex is induced by the second surface 112, the lower air, which is discharged from the blower 200 and disposed at a lower side, may also be guided to form a vortex in a direction relatively different from the direction of the vortex induced by the second surface 112. Further, the direction of the vortex formed by the first surface 111 and the direction of the vortex formed by the second surface 112 may be opposite to each other. For example, the vortex formed by the first surface 111 disposed in the circumferential direction may be formed counterclockwise, and the vortex formed by the second surface 112 may be formed clockwise. In this case, the flow of air formed by the first surface 111 may be referred to as a first flow, and the flow of air formed by the second surface 112 may be referred to as a second flow.

Therefore, the first surface 111 and the second surface 112 consistently form main flows of air, which may minimize a separate turbulent flow or vortex. Further, the second surface 112 establishes a stable flow of air, which may improve a degree of design freedom of the blower 200.

That is, the first surface 111 and the second surface 112 form the main consistent flows of air and guide the flows of air to the outlet 150, which may ensure the performance of the blower unit 1.

In addition, a groove 131 may be formed to be concave downward at an outer side of the bottom surface 130. Further, the groove 131 forms the vortex of the lower air and guides the flow of air, which may further improve the performance of the blower unit 1.

Meanwhile, the blower casing 100 may include an inlet ring 160 disposed in the inlet 140 to guide the air supplied from the intake unit 10 into the blower casing 100.

The inlet ring 160 may be disposed to be spaced apart from an upper end of the blower 200. Further, an upper surface of the inlet ring 160 may be formed as a curved surface having a predetermined curvature. For example, the upper surface may be formed in a semi-circular shape. Therefore, the inlet ring 160 may guide the air, which is introduced through the inlet 140, to the inside of the blower 200.

In addition, the blower casing 100 may further include a reverse flow prevention protrusion 170 that prevents the air discharged through the blower 200 from reversely flowing into the blower.

The reverse flow prevention protrusion 170 may be formed in an annular shape and formed by extending the inlet 140 in the axial direction. However, the present invention is not necessarily limited thereto. For example, the reverse flow prevention protrusion 170 may be disposed to be spaced apart from the inlet 140 in the radial direction in consideration of a radial size of the blower 200.

With reference to FIG. 5, the reverse flow prevention protrusion 170 may protrude from the ceiling surface 120 in the axial direction while having a predetermined length L1. In this case, the upper end of the blower 200 may be disposed to have a predetermined distance D1 in the axial direction of the ceiling surface 120. The distance D1 is smaller than the length L1. In this case, the distance D1 may be referred to as a first distance, and the length L1 referred to as a first length.

Therefore, an end of the reverse flow prevention protrusion 170 may be disposed to overlap the upper end of the blower 200 in the radial direction. In this case, the reverse flow prevention protrusion 170 may be disposed outside a band 230 and spaced apart from the band 230. Specifically, an end of the reverse flow prevention protrusion 170 may be disposed to overlap an upper side of the band 230 of the blower 200 in the radial direction. Therefore, the reverse flow prevention protrusion 170 may guide the second flow and prevent the second flow from reversely flowing into the blower 200.

Some components of the blower 200 may be disposed in the blower casing 100 and form a flow of air. Therefore, when the blower 200 operates, the air introduced through the inlet 140 may be guided by the inner surface 110 or the like and discharged to the outlet 150.

The blower 200 may be inserted into and coupled to the blower casing 100 through a hole formed in a lower portion of the blower casing 100.

With reference to FIGS. 4 to 6, the blower 200 may include a hub 210, a plurality of first wheels 220 disposed on an upper surface of the hub 210 and spaced apart from one another in the circumferential direction, the band 230 configured to connect upper portions of the plurality of first wheels 220, and a drive part 240 configured to rotate the hub 210. In addition, the blower 200 may further include a plurality of second wheels 220 disposed on a lower surface of the hub 210 and spaced apart from one another in the circumferential direction. In this case, the drive part 240 may include a shaft 241, and a motor 242 configured to rotate the shaft 241. Further, the shaft 241 may be disposed at the axial center C.

The hub 210 is formed to have a predetermined thickness in the axial direction, such that the hub 210 may include an upper surface 211 and a lower surface 212. In addition, the hub 210 may include a hole 213 formed at a center thereof so as to be coupled to an end of the shaft 241.

In addition, the hub 210 may include a curved surface formed to guide the air, which is introduced into the blower 200 through the inlet 140, to the boundary region.

The curved surface may be provided as the upper surface 211 of the hub 210 and include a first curved surface 211a and a second curved surface 211b. Further, in a vertically cross-sectional view of the hub 210, an inflection point may be formed at a point at which the first curved surface 211a and the second curved surface 211b meet together.

The first curved surface 211a may be formed to be convex upward, and the hole 213 may be disposed at a center of the first curved surface 211a. Further, the first curved surface 211a may be formed along an exponential curve.

The second curved surface 211b may be disposed outside the first curved surface 211a based on the radial direction. Further, the second curved surface 211b may be formed to be concave downward and formed along an exponential curve.

Therefore, the air flowing along the first curved surface 211a may be guided to the boundary region through the second curved surface 211b.

With reference to FIG. 6, the plurality of first wheels 220 may be disposed outside the hub 210 and spaced apart from one another in the circumferential direction. Specifically, the plurality of first wheels 220 may be disposed on the second curved surface 211b and spaced apart from one another in the circumferential direction. In this case, the first wheel 220 may be formed in a plate shape having a curved surface to increase a contact degree with the air and formed integrally with the hub 210.

The first wheel 220 may be formed to have a predetermined length in the axial direction.

In this case, positions of the first wheels 220 are disposed to be related to the boundary region, which may improve the performance of the blower unit 1.

With reference to FIG. 4, an imaginary line L, which traverses an axial center of the first wheel 220 in the radial direction, may be disposed to be offset from the boundary region based on the axial direction. In this case, the boundary region may be disposed to be lower than the line L. In this case, the offset may be defined within a range of 5 to 15% of an axial length of the first wheel 220.

Therefore, the offset clearly separates the first flow and the second flow in the upward/downward direction, which may improve an air flow rate or the like in the blower 200.

The band 230 may connect outer rims (edges) of upper ends of the plurality of first wheels 220. Therefore, the band 230 may reduce vibration and noise caused by the operation of the blower 200. In this case, the band 230 may be formed integrally with the first wheel 220.

With reference to FIG. 5, the band 230 may include a horizontal portion 231, and a lower sleeve 232 protruding downward from an outer portion of the horizontal portion 231.

The horizontal portion 231 and the lower sleeve 232 may suppress vibration and noise caused by the first wheel 220 when the blower 200 operates. In particular, the lower sleeve 232 reinforces the horizontal portion 231, which may further suppress vibration and noise in comparison with a band having only the horizontal portion 231.

The lower sleeve 232 may be formed to have a ring-shaped horizontal cross-section. Therefore, the lower sleeve 232 may connect, in the circumferential direction, outer surfaces of upper portions of the first wheels 220. In this case, the example is described in which the lower sleeve 232 is formed in a ring shape. However, the present invention is not necessarily limited thereto. For example, the lower sleeve 232 may have a plurality of plate shapes disposed to be spaced apart from one another.

With reference to FIG. 4, the blower 200 may further include support ribs 250 configured to connect lower portions of the first wheels 220 and the upper surface 211 of the hub 210.

The support ribs 250 may more securely couple the hub 210 and the first wheels 220, which may further reduce vibration and noise. In this case, the support ribs 250 may be formed integrally with the hub 210 and the first wheels 220.

With reference to FIGS. 4 and 6, the support ribs 250 may be formed by extending lower portions of inner ends of the first wheels 220. For example, the support ribs 250 may be formed by extending the lower portions of the inner ends of the first wheels 220 in a tangential direction of the first wheels 220. Therefore, apart of the air flowing along the upper surface 211 of the hub 210 may be guided by the support ribs 250.

In addition, the support rib 250 may include an upper surface 251 formed to be concave downward, and the upper surface 251 may be formed as a curved surface.

The upper surface 251 may be a curved surface having an outer portion formed to be higher than an inner portion thereof. The upper surface 251 may be formed in a ‘U’ shape or an exponential curve shape. Therefore, the upper surface 251 may guide the air to the boundary region, which may further improve the performance of the blower 200.

Specifically, because of the axial thickness of the support rib 250, the upper surface 251 of the support rib 250 may be disposed to be higher than the second curved surface 211b of the upper surface 211 of the hub 210. Therefore, the axial thickness of the support rib 250 may be used as a factor that reduces vibration and noise. The axial thickness of the support rib 250 may guide the air disposed above the boundary region. Further, in addition to the thickness, the shape of the upper surface 251 may guide the air toward a location above the boundary region.

Meanwhile, the blower 200 may further include the plurality of second wheels 260 disposed on the lower surface 212 of the hub 210 and spaced apart from one another in the circumferential direction. Therefore, the second wheel 260 may increase the air flow rate, thereby improving the performance of the blower 200.

However, in consideration of the boundary region, an axial length of the second wheel 260 needs to be shorter than an axial length of the first wheel 220. For example, the axial length of the second wheel 260 may be set within a range of 5 to 9% of the axial length of the first wheel 220. In particular, the axial length of the second wheel 260 may be about 0.07 times the axial length of the first wheel 220.

In addition, the plurality of second wheels 260 may be disposed outside the hub 210 and spaced apart from one another in the circumferential direction. Specifically, the plurality of second wheels 260 may be disposed below the second curved surface 211b and spaced apart from one another in the circumferential direction. In this case, the second wheel 260 may be formed in a plate shape having a curved surface to increase a contact degree with the air and formed integrally with the hub 210.

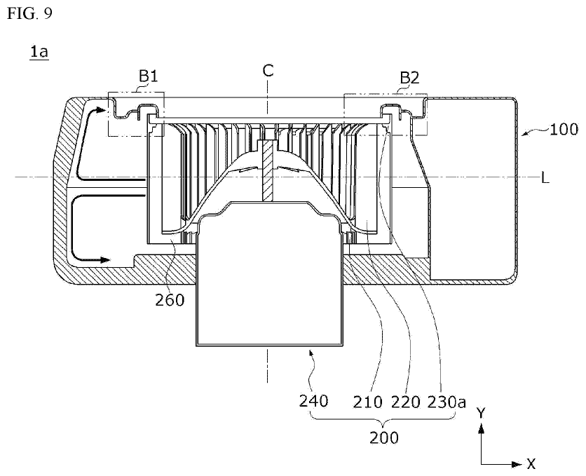

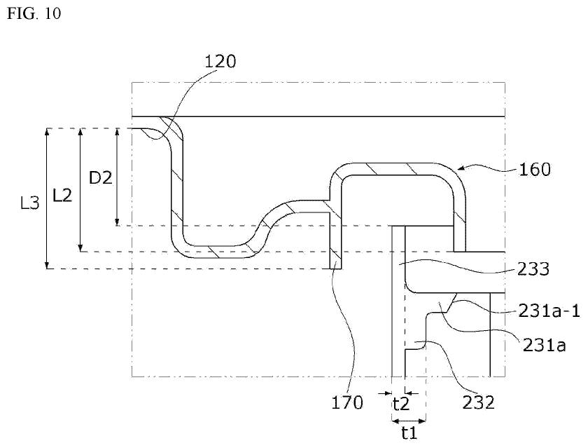

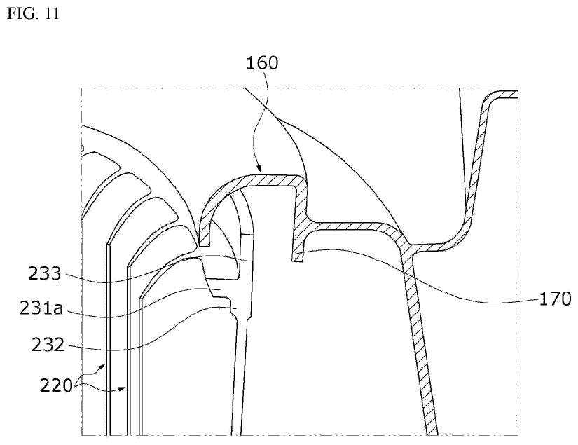

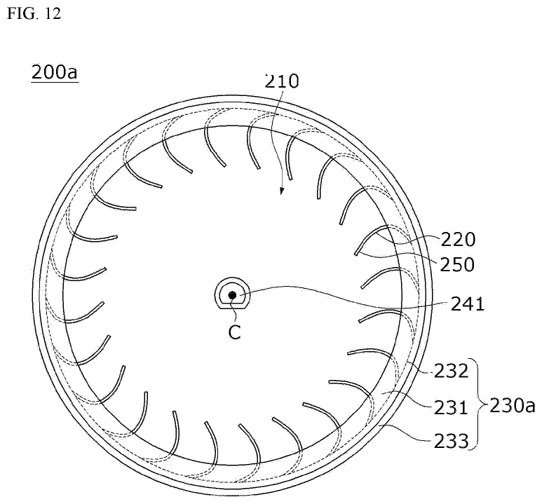

FIG. 9 is a cross-sectional view taken along line A-A in FIG. 3 and illustrating a second embodiment of the blower unit, FIG. 10 is an enlarged view of region B1 in FIG. 9, FIG. 11 is an enlarged view of region B2 in FIG. 9, and FIG. 12 is a top plan view illustrating a blower of the blower unit according to the second embodiment.

With reference to FIGS. 4 to 7 and 9 to 12, the blower unit 1a according to the second embodiment is a modified example of the blower unit 1 according to the first embodiment and differs from the blower unit 1 according to the first embodiment in terms of the shapes of the bands, the structure of the blower casing, and the arrangement relationship of the blower casing.

In the description of the blower unit 1a according to the second embodiment, the constituent elements identical to those of the blower unit 1 according to the first embodiment will be assigned with the same reference numerals, and the specific description thereof will be omitted.

With reference to FIGS. 9 to 12, the blower unit 1a according to the second embodiment may include the blower casing 100 having a space formed therein, and a blower 200a disposed in the space and configured to allow air to flow. In this case, the blower casing 100 may include the inner surface 110 having the first surface 111 and the second surface 112, the ceiling surface 120, the bottom surface 130, the inlet 140, the outlet 150, the inlet ring 160, and the reverse flow prevention protrusion 170. Further, the blower 200a may include the hub 210, the plurality of first wheels 220, the band 230a, the drive part 240, and the support ribs 250. In addition, the blower 200a may further include a plurality of second wheels 270.

With reference to FIGS. 10 to 12, the band 230a may include a horizontal portion 231a having an inclined surface 231a-1, the lower sleeve 232 protruding downward from an outer portion of the horizontal portion 231a, and an upper sleeve 233 protruding upward from the outer portion of the horizontal portion 231a.

The horizontal portion 231a may be formed in a plate shape and connect outer edges of the first wheels 220.

In addition, the inclined surface 231a-1 may be formed at an inner end, i.e., an inner peripheral surface of the horizontal portion 231a. As illustrated in FIG. 10, the inclined surface 231a-1 may be formed to be inclined outward.

The inclined surface 231a-1 may be formed to correspond to a radius of curvature of the inlet ring 160. Because the inclined surface 231a-1 is short in length, the inclined surface 231a-1 need not be particularly configured to have a curvature. However, the inclined surface may be configured to be almost coincident with a curvature of the inlet ring 160 to maintain a smooth flow of air. In this case, the inclined surface 231a-1 may be formed between the first wheels 220 based on the circumferential direction.

Because the band 230a has the upper sleeve 233, the air flowing in the blower casing 100 collides with the upper sleeve 223. For this reason, vibration and noise of the blower 200a may increase.

Therefore, a radial thickness t1 of the lower sleeve 232 may be larger than a radial thickness t2 of the upper sleeve 233 to reduce vibration and noise caused by the upper sleeve 233. In this case, the upper sleeve 233 may be disposed to overlap the lower sleeve 232 in the axial direction.

The upper sleeve 233 may be formed to protrude upward from the outer portion of the horizontal portion 231a. Further, the upper sleeve 233 may be formed to have a ring-shaped horizontal cross-section.

In addition, the upper sleeve 233 may be formed on the horizontal portion 231a while having a predetermined height. An end of the upper sleeve 233 may be disposed at a predetermined spacing distance D2 from the ceiling surface 120. Further, as illustrated in FIG. 10, the end of the upper sleeve 233 may be disposed between an end of the inlet ring 160 and the reverse flow prevention protrusion 170 based on the radial direction. For example, the end of the upper sleeve 233 may be disposed outside the inlet ring 160 and disposed inside the reverse flow prevention protrusion 170.

In this case, the inlet ring 160 may be formed to have a predetermined axial length L2 based on the ceiling surface 120, and the reverse flow prevention protrusion 170 may be formed to have a predetermined axial length L3 based on the ceiling surface 120. Further, the axial length L2 of the inlet ring 160 may be longer than the spacing distance D2 of the upper sleeve 233 and shorter than the axial length L3 of the reverse flow prevention protrusion 170. Therefore, the end of the upper sleeve 233 may be disposed to overlap a lower end of the inlet ring 160 and a lower end of the reverse flow prevention protrusion 170 in the radial direction. In this case, the axial length L2 of the inlet ring 160 may be referred to as a second length. The axial length L3 of the reverse flow prevention protrusion 170 disposed on the blower unit 1a according to the second embodiment may be referred to as a third length. Further, the spacing distance D2 of the upper sleeve 233 may be referred to as a second distance.

With reference to FIG. 10, the inlet ring 160, the reverse flow prevention protrusion 170, and the upper sleeve 233 may define a flow path having an inverted ‘U’ shape.

Therefore, the reverse flow prevention protrusion 170 and the upper sleeve 233 may implement a dual covering wall structure, thereby suppressing a reverse flow of the second flow. In addition, the inlet ring 160 and the upper sleeve 233 may also implement a dual covering wall structure, thereby preventing the air, which is supplied from the intake unit 20, from leaking in the radial direction.

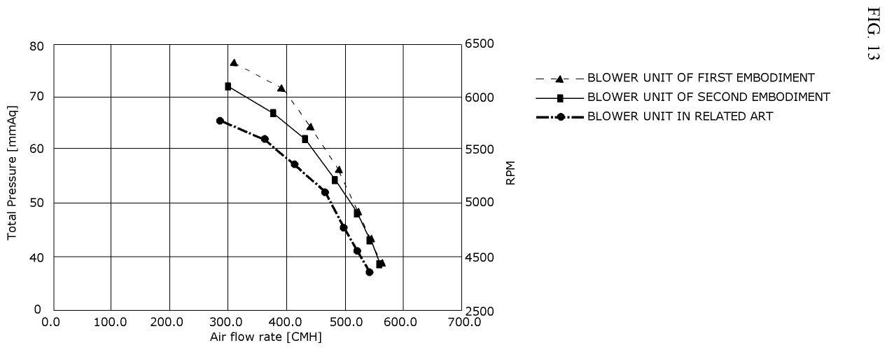

FIG. 13 is a graph illustrating performance of the blower unit according to the embodiment.

With reference to FIG. 13, it can be ascertained that the air flow rate in the blower unit 1 (1a) according to the embodiment increases when the pressure is constant. In particular, it can be ascertained that the blower unit 1a according to the second embodiment may obtain a higher air flow rate than the blower unit 1a according to the first embodiment and the blower unit in the related art.

That is, it can be ascertained that the blower unit 1 (1a) according to the embodiment increases the air flow rate and reduces vibration and noise when the pressure and RPM are constant.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to modifications and changes fall within the scope of the present invention defined by the appended claims.

### DESCRIPTION OF REFERENCE NUMERALS

1, 1a: Blower unit, 20: Intake unit, 30: Air conditioning unit, 100: Blower casing, 110: Inner surface, 111: First surface, 112: Second surface, 170: Reverse flow prevention protrusion, 200, 200a: Blower, 210: Hub, 220: First wheel, 230, 230a: Band, 231, 231a: Horizontal portion, 231a-1: Inclined surface, 232: Lower sleeve, 233: Upper sleeve, 240: Drive part, 241: Shaft, 250: Support rib, 260: Second wheel

1-16. (canceled)

17. An air conditioner for a vehicle, the air conditioner comprising:
an air conditioning unit having a heat exchanger disposed therein; and
a blower unit configured to supply air to the air conditioning unit,
wherein the blower unit comprises:
a blower casing having a bottom surface and an inner surface; and
a blower configured to allow the air to flow toward the inner surface,
wherein the inner surface comprises:
a first surface; and
a second surface disposed on the first surface and inclined, and
wherein the first and second surfaces divide a direction of the air, which is allowed to flow by the blower, into at least two directions.

18. The air conditioner of claim 17, wherein the blower comprises:
a hub;
a plurality of first wheels disposed on an upper surface of the hub and spaced apart from one another in a circumferential direction;
a band configured to connect upper portions of the plurality of first wheels; and
a drive part configured to rotate the hub, and
wherein the upper surface of the hub is formed as a curved surface and guides air to a boundary region in which the first and second surfaces meet together.

19. The air conditioner of claim 18, wherein the curved surface comprises:
a first curved surface formed to be convex upward; and
a second curved surface formed to be concave downward.

20. The air conditioner of claim 18, wherein the boundary region is disposed to have a predetermined offset from an imaginary line that traverses an axial center of the first wheel in a radial direction.

21. The air conditioner of claim 18, wherein the boundary region is disposed to be lower than an imaginary line that traverses an axial center of the first wheel in a radial direction.

22. The air conditioner of claim 18, wherein a flow of air formed in a radial direction by the blower forms vortices by means of the first and second surfaces, and
wherein a direction of the vortex formed by the first surface and a direction of the vortex formed by the second surface are opposite to each other.

23. The air conditioner of claim 18, wherein the band comprises:
a horizontal portion configured to connect upper edges of the plurality of first wheels;
an upper sleeve protruding upward from the horizontal portion; and
a lower sleeve protruding downward from the horizontal portion, and
wherein a radial thickness of the lower sleeve is larger than a radial thickness of the upper sleeve.

24. The air conditioner of claim 23, wherein an inner peripheral surface of the horizontal portion is formed as an inclined surface inclined outward.

25. The air conditioner of claim 24, wherein the upper sleeve is disposed to overlap the lower sleeve in an axial direction.

26. The air conditioner of claim 23, wherein the blower casing further comprises a reverse flow prevention protrusion protruding downward from a ceiling surface, and
wherein an end of the reverse flow prevention protrusion disposed outside the band is disposed to overlap the upper sleeve of the band in a radial direction.

27. The air conditioner of claim 18, wherein the blower casing further comprises a reverse flow prevention protrusion protruding downward from a ceiling surface, and
wherein an end of the reverse flow prevention protrusion disposed outside the band is disposed to overlap a horizontal portion of the band in a radial direction.

28. The air conditioner of claim 18, wherein the blower further comprises support ribs configured to connect lower portions of the first wheel and the upper surface of the hub.

29. The air conditioner of claim 28, wherein an upper surface of the support rib is formed as a curved surface formed to be concave downward.

30. The air conditioner of claim 18, wherein the blower further comprises a plurality of second wheels disposed on a lower surface of the hub and spaced apart from one another in a circumferential direction.

31. The air conditioner of claim 17, wherein the blower casing comprises a groove formed on the bottom surface.

32. An air conditioner for a vehicle, the air conditioner comprising:
an air conditioning unit having a heat exchanger disposed therein; and
a blower unit configured to supply air to the air conditioning unit,
wherein the blower unit comprises:
a blower casing; and
a blower configured to allow air to flow in the blower casing,
wherein the blower comprises:
a hub;
a plurality of wheels disposed on the hub and spaced apart from one another in a circumferential direction;
a band configured to connect upper portions of the plurality of wheels; and
a drive part configured to rotate the hub,
wherein the band comprises:
a horizontal portion configured to connect upper edges of the plurality of wheels; and
an upper sleeve protruding upward from the horizontal portion,
wherein the blower casing comprises a reverse flow prevention protrusion protruding downward from a ceiling surface, and
wherein an end of the reverse flow prevention protrusion disposed outside the band is disposed to overlap an upper sleeve of the band in a radial direction.

33. The air conditioner of claim 32, wherein the band further comprises a lower sleeve protruding downward from the horizontal portion, and
wherein a radial thickness of the lower sleeve is larger than a radial thickness of the upper sleeve.

34. The air conditioner of claim 32, wherein the blower casing comprises a bottom surface and an inner surface,
wherein the inner surface comprises a first surface and a second surface disposed on the first surface and inclined, and
wherein the first and second surfaces divide a direction of the air, which is allowed to flow by the blower, into at least two directions.

35. The air conditioner of claim 34, wherein the blower casing comprises a groove formed on the bottom surface.
